(19) United States
(12) Patent Application Publication
(10) Pub. No.: US 2014/0250113 A1
(43) Pub. Date: Sep. 4, 2014

(54) GEOGRAPHIC RELEVANCE WITHIN A SOFT COPY DOCUMENT OR MEDIA OBJECT

(71) Applicant: INTERNATIONAL BUSINESS MACHINES CORPORATION, Armonk, NY (US)

(72) Inventors: Gregory D. Dallari, Poughkeepsie, NY (US); Thomas E. Murphy, JR., Hopewell Junction, NY (US); Adiswong Puiam, Poughkeepsie, NY (US)

(73) Assignee: INTERNATIONAL BUSINESS MACHINES CORPORATION, Armonk, NY (US)

(21) Appl. No.: 13/783,684

(22) Filed: Mar. 4, 2013

(51) Int. Cl. G06F 17/30

(52) U.S. Cl. CPC G06F 17/30241
USPC 707/724

(57) ABSTRACT

A technique is provided for identifying geographic context in a media object to embed meta tags for the geographic context in the media object. Input is received of the media object including geographic relevant expressions. Each of the geographic relevant expressions in the media object is identified for display to a user. The geographic relevant expressions in the media object are displayed with an option for the user to enter values for each of the geographic relevant expressions. The values are respectively included in meta tags. The meta tags are assigned to the geographic relevant expressions in the media object, such that the meta tags include the values respectively corresponding to each of the geographic relevant expressions. The meta tags having the values for the geographic relevant expressions are embedded in the media object, such that the meta tags in the media object are available for searching and indexing.

### BACKGROUND

Exemplary embodiments relate to soft copy documents/objects, and more specifically, to a system for enhancing geographic relevance references within a document and/or media object.

A soft copy is an unprinted digital document file which may also be a scanned in copy of a printed document. This term is often contrasted with hard copy. A soft copy can usually be viewed through an appropriate viewing or editing program, such as word processing programs, database programs, or presentation software, depending on the file type. A soft copy can be transported from one computer to another through file transfer/downloading mechanisms such as ftp or http, as an email attachment, or through USB (universal serial bus) drives and other disk drives. Also, the soft copy can be uploaded to the Internet for viewing by multiple users.

A soft copy of a document is part of electronic media. Electronic media are media that use electronics or electromechanical energy for the end-user (audience) to access the content. This is in contrast to static media (mainly print media or hard copy). The primary electronic media sources familiar to the general public are better known as video recordings, audio recordings, multimedia presentations, slide presentations, CD-ROM (compact disc read-only-memory), and online content.

### BRIEF SUMMARY

According to an exemplary embodiment, a method is provided for identifying geographic context in a media object to provide meta tags for the geographic context in the media object. The method includes receiving input of the media object having geographic relevant expressions and identifying each of the geographic relevant expressions in the media object for display to a user. The method also includes displaying each of the plurality the geographic relevant expressions identified in the media object, the geographic relevant expressions displayed by the software tool with an option for the user to enter values for each of the geographic relevant expressions. The method further includes assigning the meta tags to the geographic relevant expressions in the media object, the meta tags comprising the values respectively corresponding to each of the geographic relevant expressions.

According to another exemplary embodiment, a computing device configured for identifying a geographic context in a media object to provide a meta tag for the geographic context in the media object is provide. The computing device comprises a processor and a software tool configured to operate on the processor. The software tool being configured to receive input of the media object comprising a geographic relevant expression, identify the geographic relevant expression in the media object for display to a user, and display the geographic relevant expression identified in the media object, the geographic relevant expression displayed with an option for the user to enter a value for the geographic relevant expression, wherein the value is comprised in the meta tag. The software tool being further configured to assign the meta tag to the geographic relevant expression in the media object, the meta tag comprising the value corresponding to the geographic relevant expression.

According to a further exemplary embodiment, a computer program product for identifying geographic context in a media object to provide meta tags for the geographic context in the media object via a computing device is provided. The computer program product comprises a computer readable storage medium having computer readable program code embodied therewith. The computer readable program code being configured for receiving, by a software tool executed on a computing device, input of the media object comprising a plurality of geographic relevant expressions and identifying each of the plurality of geographic relevant expressions in the media object for display to a user. The computer readable program code being further configured for displaying each of the plurality the geographic relevant expressions identified in the media object, the geographic relevant expressions displayed by the software tool with an option for the user to enter values for each of the geographic relevant expressions, wherein the values are respectively comprised in the meta tags and assigning the meta tags to the geographic relevant expressions in the media object, the meta tags comprising the values respectively corresponding to each of the geographic relevant expressions.

According to another exemplary embodiment, a method for identifying geographic context in a media object is provided. The method includes receiving, by a software tool executed on a computing device, input of the media object having one or more geographic relevant expressions. The method also includes identifying each of the one or more geographic relevant expressions in the media object for display to a user in response to at least one of the user editing in a document of the media object and a scan being performed for geographic accuracy of the document and displaying the one or more geographic relevant expressions identified in the media object, the one or more geographic relevant expressions being displayed by the software tool with at least one of a suggestion of an alternative wording for the geographic relevant expressions and an option for the user to correct the one or more geographic relevant expressions.

Additional features are realized through the techniques of the present disclosure. Other systems, methods, apparatus, and/or computer program products according to other embodiments are described in detail herein and are considered a part of the claimed invention. For a better understanding of exemplary embodiments and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features of the present disclosure are apparent from the following detailed description taken in conjunction with the accompanying drawings in which:

FIG. 1 illustrates an excerpt with potentially ambiguous geographic relevant words and phrases according to an exemplary embodiment.

FIG. 2 is a block diagram of a system according to an exemplary embodiment.

FIG. 3 is a high level diagram via a software tool for allowing an author, editor, and/or software service to identify and return geographic relevant words and phrases in a media object, and to store a meta tag for each geographic relevant word and phrase according to an exemplary embodiment.

FIG. 4 illustrates details of an image scanner, printer, and copier according to an exemplary embodiment.

FIG. 5 illustrates a view displayed on a display to an author and editor of an excerpt in a media object after potentially ambiguous geographic relevant words and phrases are identified according to an exemplary embodiment.

FIG. 6 illustrates a view displayed to an author and editor in which a software tool has attached/assigned fields as metadata to each geographic relevant word and phrase according to an exemplary embodiment.

FIG. 7 illustrates a metadata table of the assigned/attached fields respectively corresponding to identified geographic relevant words and phrases, in which the metadata table is embedded in a media object according to an exemplary embodiment.

FIG. 8 illustrates a view displayed to a reader of highlighted words that define potentially ambiguous geographic relevant terms and phrases according to an exemplary embodiment.

FIG. 9 illustrates a method for identifying geographic context in a media object to embed meta tags for the geographic context in the media object according to an exemplary embodiment.

FIG. 10 illustrates an example of a computer having capabilities, which may be included in exemplary embodiments.

### DETAILED DESCRIPTION

When reading articles in various media (printed or otherwise) there is a relevance of geography which is generally implied by geographic words used in the article or the source original publication. In come cases, there is a geographic relevance associated with the original publication whether a newspaper, magazine, or perhaps a periodical, or whether a newsletter mailed, emailed, or web-published.

In a form of reuse, many articles are recycled and republished in various web venues, quite often simply reprinting the article word for word as originally published. Many authors of such articles never envisioned their context of articles to be removed and the article reused in an electronic format without the content removed from its context. Consequently, as these articles are republished at later dates in different venues (e.g., on the Internet, syndicated copy media, magazines, or other periodicals) confusion may occur.

Prior to the Internet, smart phones, and online media, the main source of information was available in printed (hard copy) newspapers and the date and location was anchored on each page. However, with the Internet, word processing files (such as Word® software), electronic presentations (such as PowerPoint® software), etc., the author now has to be diligent in making more specific temporal and geographic references in his or her articles. Many authors do not take the diligence to make specific temporal and geographic references.

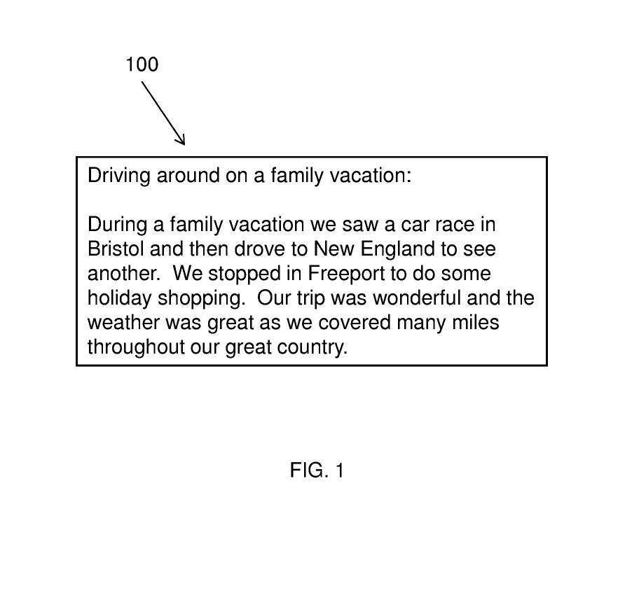

As an example, consider the following ambiguous geographic terms and/or references that are taken from a simple magazine excerpt 100 in FIG. 1. The ambiguous terms, geographic relevant expressions, geographic relevant words, and/or geographic references in the magazine excerpt 100 are “New England,” “Bristol” and “Freeport.” These terms can be easily taken out of context or misinterpreted, which is a growing problem with the current exponential growth of electronic media.

With respect to reusing, or providing, this article as electronic media on networks (including the Internet) and/or storage devices (including optical disc storage (e.g., Blu-Ray disc™, digital versatile disc, compact disc, etc.), solid state storage, tape, etc.), this article has some shortcomings in terms of searchability. It is contemplated that any type of storage (including off line storage) and/or medium may be utilized to store and communicate electronic media (which includes any type of media object or information); accordingly, any Internet examples discussed herein are for explanation purposes and are not meant to be limiting. Consider an example in which a user may want to perform a search to identify references to no hitters in the in Florida high school baseball games. An Internet or web search engine (such as, e.g., Google® search engine, Bing® search engine, etc.) might not readily identify this article and would (at best) be plagued with many false positive search hits. Authors typically use geographic relevant words such as the name of a city or region, which may be overly broad or open to multiple interpretations. For example, there are at least fifty cities in the United States that have the name Newport. Accordingly, searches for information with a desired geographic context are often not effective.

Continuing with reference to the article in the magazine excerpt 100 in FIG. 1, assume someone is interested in searching and finding the events highlighted in the above example for the article, and for the sake of discussion, assume the article included the reference to a “no hitter in Connecticut.” A search of “no hitter” and “New England,” would likely not find the article. Accordingly, in order to find an article with such a reference the user would have to have entered the exact geographic reference term used by the author, in this case “Connecticut.”

A (Internet) search engine is an information retrieval system designed to help find information stored on a computer system or network of computer systems such as the Internet or World Wide Web (typically referred to as web). The terms Internet and web (or network) may be used interchangeably. The search results are usually presented in a list and are commonly called hits. Search engines help to minimize the time required to find information and the amount of information which must be consulted, akin to other techniques for managing information overload. To provide a set of matching items that are sorted according to some criteria quickly, a search engine will typically collect metadata (e.g., meta tags) about the group of items under consideration beforehand through a process referred to as indexing. The index typically requires a smaller amount of computer storage, which is why some search engines only store the indexed information and not the full content of each item, and instead provide a method of navigating to the items in the search engine result page. Alternatively, the search engine may store a copy of each item in a cache so that users can see the state of the item at the time it was indexed, for archive purposes, or to make repetitive processes work more efficiently and quickly.

A web crawler is a computer program that browses the World Wide Web in a methodical, automated manner or in an orderly fashion. Other terms for web crawlers are ants, automatic indexers, bots, web spiders, and web robots. This process is called web crawling or spidering. Many sites, in particular search engines, use spidering as a means of providing up-to-date data for indexing. Web crawlers are mainly used to create a copy of all the visited pages for later processing by a search engine that will index the downloaded pages to provide fast searches for users.

Returning to the example in FIG. 1, after web crawlers go through the indexing phase of registering words within the content (such as the article in FIG. 1), the index simply includes the words without geographic context; hence using a search engine to search on the phrase “New England” will quite naturally trigger on those specific words having been indexed in various articles.

Exemplary embodiments provide a technique for automatically setting meta-tag information (whether if it is Internet HTML (hyper text markup language) tags, XML (extensible markup language) tags, and/or other file/object/media specific tags) that are useful within the (currently) available search engine capabilities. Exemplary embodiments provide one or more software applications configured to (automatically) identify the geographic context of a word or phrase and assign a specific (searchable) value to a transparent meta tag (that will be) embedded in the object.

When writing an article, authors often may write the name of a town, city or region where the author assumes the reader will properly interpret the context of the name of the town or city. Authors and readers of documents typically use geographic relevant words. As a reader, the one challenge is to understand the intended geographic reference in context. As an author, a challenge is to create the proper geographic reference.

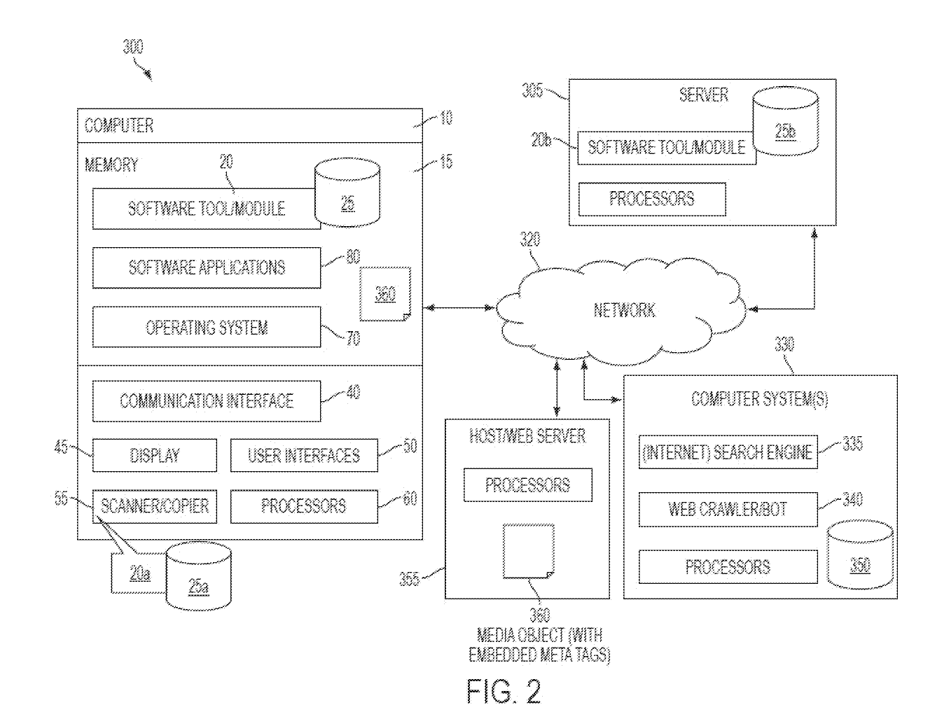

According to an exemplary embodiment, a software tool 20 (shown in FIG. 2) is configured to receive/download/scan a historical document (e.g., a hardcopy for this example, but could be in any media format) and convert the document to an electronic format (an electronic media object, i.e., a soft copy). The software tool 20 is configured to anchor a geographic reference within the metadata of the electronic media object to give a context to geographic relevance words. The software tool 20 can make a real geographic change and/or append an addendum to the electronic media object (soft copy document) to reconfigure the article, such that the electronic media is searchable on a network (such as the Internet) or enclave. Also, the software tool 20 can make a real geographic change and/or append an addendum to the electronic media object such that the electronic media is on a desktop of a Windows® operating system using a file search, Google® desktop, and/or any other operating system search facility/function. The software tool 20 provides improvements in this field which will benefit deep analytical and language interpretation. Additionally, performing a web search for information related to a specific location would no longer miss key documents (i.e., web documents and/or web pages) and greatly reduces the amount of false positives returned.

Continuing with reference to FIG. 2, a block diagram of a system 300 for providing geographic context to geographic relevant words in an electronic media object (documents) in accordance with an exemplary embodiment is shown. Note that “media object” is meant to refer to an electronic file that can be stored in an electrical and electrical mechanical manner. The system 300 depicts a computing device 10 which may be one or more servers, mobile devices (such as a smart phone, tablet, laptop computer, etc.), or any type of computer processing device. The computing device 10 may include and/or be coupled to memory 15, a communication interface 40, a display screen 45, user interfaces 50, processors 60, operating system 70, and software tools 20. The communication interface 40 comprises hardware and software for communicating over a network 320 (such as the Internet (i.e., World Wide Web)) including a wired and/or wireless network. The network 320 includes routers, servers, switches, cell phone towers, and other network elements for processing and routing data (including packets). The user interfaces 50 may include, e.g., a track ball, mouse, pointing device, keyboard, keypad, touch screen, etc., for interacting with the computing device 10, such as inputting information, making selections, etc. The computing device 10 includes memory 15 which may be a computer readable storage medium. The memory 15 stores the operating system 70, and the operating system 70 is configured to generally operate the functions of the computer system 10.

One or more software applications such as the software tool 20 (module) may reside on or be coupled to the memory 15, and the software tool 20 comprises logic and software components to operate and function in accordance with exemplary embodiments in the form of computer executable instructions. The software tool 20 may include a graphical user interface (GUI) (displayed on the display screen 45) which the user can view and interact with according to exemplary embodiments. Although the software tool 20 is shown as a single element in FIG. 2 for conciseness, the software tool 20 may represent numerous software components (or modules) according to exemplary embodiments. Also, the functions of the software tool 20 are represented in whole or part as software tools 20a and 20b, and any discussion for the software tool 20 applies to software tools 20a and 20b. The software tool 20 may include and/or access a database 25. The database 25 can be an ontology database and/or geographic database which include geographic relevant keywords to be matched against an electronic media object 360 by the software tool 20. An identical database 25 is represented in whole or part as database 25a and 25b, and any discussion for the database 25 applies to database 25a and 25b. The software tool 20 may include an ontology engine configured to perform a search based on the geographic relevant words in the database 25 as discussed herein.

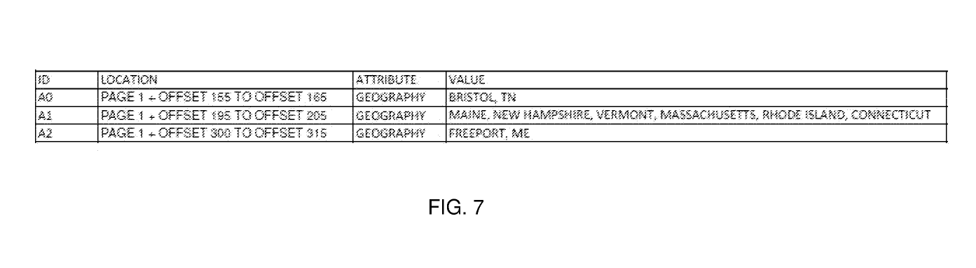

For example, the software tool 20 is configured to search the electronic media object 360 for these geographic relevant words in the database 25, and then identify/display on the display 45 the geographic relevant words, phrases, and references to the user (e.g., author, editor, etc., of the media object 360 being searched). For each geographic relevant word identified (highlighted) on the display 45 to the author, the software tool 20 is configured to ask and allow the author to input a value (such as a city and state, geographic region, latitude/longitude, etc.) to correspond to the geographic relevant word. The software tool 20 is configured to store the value for each geographic relevant word in the electronic media object 360 as a meta tag. Then, the software tool 20 embeds/stores the meta tags respectively corresponding/anchored to each geographic relevant word in the electronic media object 360 itself, such that the embedded meta tags and the electronic media object 360 form a single searchable package identified as electronic media object 360. This electronic media object 360 now has a value embedded as a meta tag (including metadata in metadata table 800 shown in FIG. 7) for each ambiguous geographic relevant word identified in the electronic media object 360 by the software tool 20, such that a web crawler can search, find, and index these values for the geographic relevant words in the electronic media object 360. For example, a web crawler 340 in a computer system 330 (e.g., server farm) of an Internet search engine company/entity can search for and index the meta tags (which are the values of the (ambiguous) geographic relevant words of the electronic media object 360) in an indexing database 350. Subsequently or concurrently, when a search engine 335 (such as the Google® search engine) is tasked to search (in the index database and/or over the network 320) for terms including and/or combined with the values in the meta tags (corresponding to the ambiguous geographic relevant words in the electronic media object 360), the search engine 335 will return (locate) the electronic media object 360 having the meta tags, e.g., hosted on the server 355. The electronic media object 360 may be a web page and/or in a web page hosted by the host server 355 on the Internet (i.e., over the network 320). The author/user may have previously uploaded the electronic media object 360 to the host server 355, which can now be properly indexed by the web crawler 340 and searched/located by the search engine 335.

As discussed herein, an exemplary embodiment provides a technique for allowing an author, an editor, a software service (e.g., provided by an entity of server 305) and/or the software tool 20 to recognize/display the relative context (e.g., word context) of object entities (which are geographic relevant words and word phrases in the electronic media object 360), to highlight and/or alert for ambiguity for geographic relevant words and phrases, to offer alternatives for geographic relevant words and phrases, and to attach and/or store portable meaningful meta tags (attributes/values) within the electronic media object 360 for these geographic relevant words and phases. These meta tags provide the ability for conventional indexing and searching by web crawlers 340 and search engines 335. Also, the meta tag information may be stored within the media object or externally as taught during our other invention.

In one embodiment, the software application 80 can be a word processing application or any other software application for creating a document, and the software application 80 integrates the features of and/or works in cooperation with the software tool 20 (e.g., as a plug-in, optional tool, etc.). For example, features of the software tool 20 can be integrated in a conventional word processing application, such as Word® software. As the user types in (i.e., edits) a word processing document of the software application 80, the software tool 20 can scan the entire document of the electronic media object 360 much like the deployment of a spell/grammar checker at completion of the media object 360 and/or dynamically as the media object 360 is being edited (e.g., in the word processing application). The software tool 20 is configured to display on the display 45 a warning/prompt while the user is writing/authoring the document such that a geographical ambiguity is observed by the processing program (now incorporating the software tool 20), the user may be prompted with an option to better articulate a geographical reference for the geographic relevant words or phrases and/or the user may be provided with a suggestion of alternative wording for the geographic relevant words and phrases. Further, the software tool 20 may be configured so that the user can set a varied metric to identify and/or target a degree of geographical accuracy. For example, if the geographical accuracy of the software tool 20 is set to “absolute” (e.g., which may be a strict adherence to providing geographical accuracy), then the software tool 20 is configured to highlight (on the display 45) all geographic references and then to prompt the user to select an exact geographic reference. The exact geographic reference may be selected by selecting a point on a map or by entering a latitude and longitude. Furthermore, the exact geographic reference may be selected to be a geographic area (such as a city, state, or region) rather than a single point.

Accordingly, the software tool 20 can operate in real time during the authorship phase, as well as in a batch (post-authorship) manner. In one implementation, the software tool 20 can provide real time processing for identifying and correcting geographic relevant words and phrases (in terms of geographic wording) to be more explicit, without storing any metadata corresponding to the geographic relevant words for the media object 360. Although an example was discussed for an absolute geographic accuracy above, it is understood that the metric for geographic accuracy (applied by the software tool 20) can be varied by the user to include, e.g., no degree of geographic accuracy, a low degree of geographic accuracy, a medium degree of geographic accuracy, a high (absolute) degree of geographic accuracy, and so forth. At anytime, the user can initiate a scan of the document for geographic accuracy as discussed herein.

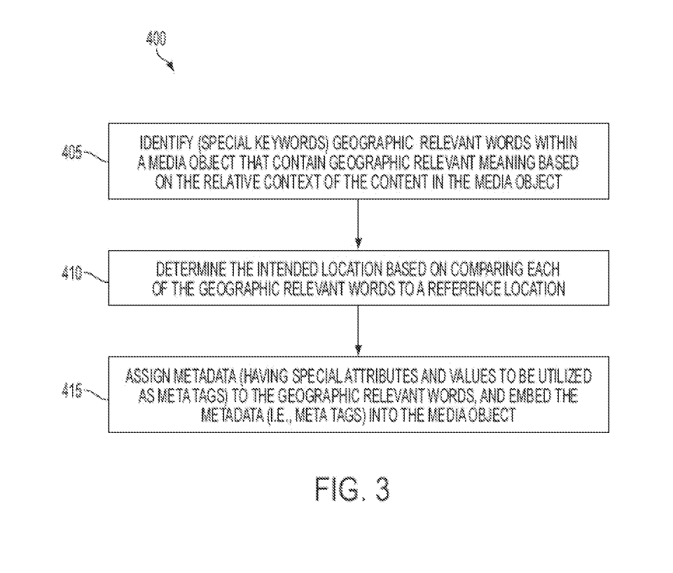

FIG. 3 illustrates a high level diagram 400 via the software tool 20 of allowing an author, editor, and/or software service to identify and return geographic relevant words and phrases in a media object and store a meta tag for each geographic relevant word and phrase according to an exemplary embodiment.

The software tool 20 is configured to identify geographic relevant words (special keywords) within the electronic media object 360 (e.g., file, components, sections, documents, etc.) in which the geographic relevant words contain a geographic relevant/sensitive meaning based on the relative context of the content in the media object 360 at block 405. The media object 360 is stored/captured in electronic format, e.g., in the memory 15. For example, the software tool 20 may identify each of the geographic relevant words in the media object 360 for display to a user in response to the user typing in a document of the media object 360 and/or a scan being performed for geographic accuracy of the document. The geographic relevant words can be displayed a suggestion of an alternative wording for the geographic relevant words and/or an option for the user to correct the geographic relevant words.

In exemplary embodiments, the software tool 20 is configured to automatically determine the intended location based on comparing the geographic relevant words to a reference location at block 410. The reference location may be requested from the author (editor), and the author inputs the reference location to be used by the software tool 20. Also, the reference location may be inferred from the media object 360 itself, e.g., the reference location may simply be the media object publish location (as determined by a scan performed by the software tool 20 and/or input by the author/editor). Additionally, the software tool 20 is configured to determine (or the user can input) the reference location based on the context of the content itself in the media object 360. The software tool 20 is configured to scan the media object 360 to determine borders, margins, box dividers, and column dividers. Also, the software tool 20 determines/distinguishes the content (i.e., the text of the article which may be within a box, column, border, and/or any encapsulated form) of the media object 360 from text surrounding the content. Text surrounding/outside of the content may be text in the margins, borders, and/or generally outside of the encapsulated content. The software tool 20 is configured to determine that a location found outside (e.g., in a header, footer, etc.) of the content is not (automatically) utilized as the reference location that is used to generates values for the meta tags.

At block 415, the software tool 20 is configured to assign metadata, having special attributes and values to be utilized as meta tags, to the geographic relevant words, and the software tool 20 embeds the metadata (i.e., meta tags) into the media object 360. Further information regarding assigning and embedding metadata is disclosed in application Ser. No. 12/555,171 filed Sep. 8, 2009, entitled “Processing Special Attributes Within A File” which is hereby incorporated in its entirety by reference. In one implementation, the software tool 20 may attach the metadata along with the media object 360 instead of embedding the metadata.

Execution of the scanning/inference logic (for identifying and highlighting the geographic relevant words for display to the user) can be done via stand software components in the software tool 20 and/or via software services shown as the server 305 having the software tool 20b. Also, the software tool 20 may be integrated as a feature in a word processing program. The software tool 20 is configured for an author and/or editor to override meta tags automatically assigned by the software tool 20 and assign meaningful meta tags himself. In one embodiment, the author could manually highlight and assign desired meta tags via the software tool 20. Geographic sensitive/relevant words, phrases, and terminology within electronic media object 360 (e.g., text, audio, etc.) can readily be identified using existing software modified the software tool 20 as discussed herein. Optical character recognition (OCR) software can be designed to do this in conversion to text applications. The technique of exemplary embodiments goes beyond existing software by identifying, interpreting, and assigning these geographic relevant words and phrases into succinct geographic references (geographic values in corresponding meta tags) for direct portable inclusion within and/or associated with the electronic media object 360.

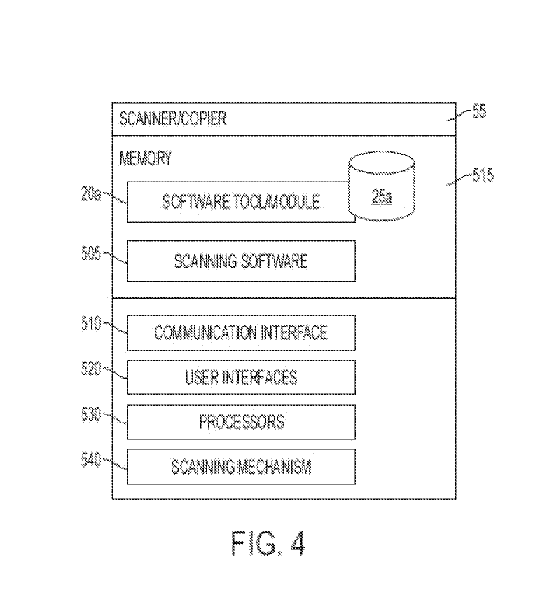

In one embodiment, the software tool 20 can be integrated into a scanner, such that the scanner 55, to provide enhanced scanning The scanner 55 may be configured with functions of scanners and printer combinations. FIG. 4 illustrates further details of the scanner 55 having the software tool 20a as discussed below. The software tool 20 (designated as software tool 20a in the scanner 55) is configured to allow post OCR-scanned documents to be processed to create pertinent meta tags which are to be indexed with the resultant soft copy output (i.e., the media object). This further improves on paper-less office solutions.

Once the geographic relevant word and relevant location (i.e., the relevant location is the value in a meta tag for that particular geographic relevant word) has been input/established by the author, editor, and/or software tool 20 (which may be a software service offered by an entity through the server 305), the author/editor has the an option displayed by the software tool 20 to correct and/or adjust the wording (of the value) appropriately based on the actual location that should be input as the value.

The search engine 335 would be able to search, determine, and locate a definitive location for each geographic relative word by finding its corresponding meta tag. Additionally, the embedded meta tag (via the software tool 20) allows a reader to view (via, e.g., a mouse over) the value of the meta tag assigned/corresponding to each geographic relevant word in the document (i.e., the electronic media object 360) which provides the reader a definitive location for any ambiguous geographic relevant words and phrases. As presented in application Ser. No. 12/555,171 filed Sep. 8, 2009, the author/editor has the ability to assign special attributes/values to such geographic relevant words as discussed herein. Both the discovery software (e.g., search engine 335) and the direct beneficiary (the user/reader) will benefit by having the ability to discern an actual location based off of geographic sensitive/relevant words, thereby eliminating the confusion of geographic relevance within documents.

Returning to FIG. 2, the computer system 10 may include and/or be operatively connected to the image scanner 55 (e.g., a fax, copier, and printer device). The scanner 55 is configured to scan in a hard copy of a document (such as a magazine, newspaper, dissertation, journal, periodical, etc., and output a digital image (such as the electronic media object shown in FIG. 1). In computing, an image scanner (such as the scanner 55) is a device that optically scans images, printed text, handwriting, and/or an object, and converts them to a digital image. An example of the scanner 55 may include variations of the desktop (or flatbed) scanner where the document is placed on a glass window for scanning Other examples of the scanner 55 may be hand-held scanners, where the device is moved by hand, and mechanically driven scanners that move the document. Further, details of the scanner 55 are illustrated in FIG. 4. In FIG. 4, the scanner 55 may include memory 515, a communication interface 510 (e.g., for communicating with the computer system 10 and the network 320), user interfaces 520 (e.g., keypad, touch screen, display screen, etc.), processors 530, and a scanning mechanism 540. The scanning mechanism 540 includes the hardware and software (such as scanning software 505) for scanning and copying an image. The scanning mechanism 540 may include a charge-coupled device (CCD), a CCD array, a drum scanner, and/or a contact image sensor (CIS) as the image sensor.

As discussed herein, the scanner 55 may include the software tool 20a (e.g., as an add-on or plug-in) along with a database 25a of geographic sensitive/relevant words and phrases. The scanner 55 can be a stand alone device in which the software tool 20a with database 25a can operate and function (identically or modified as desired) as discussed herein for the software tool 20 and database 25.

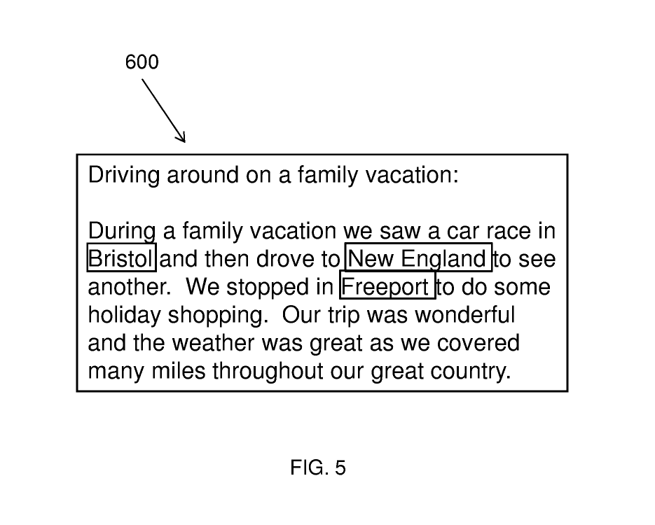

An example was provided above for the magazine excerpt 100 of FIG. 1. The hard copy of the magazine excerpt 100 has been scanned in by the scanner 55 and can be represented as a soft copy (file). In this example, this electronic soft copy (file) is media object 360. The software tool 20 receives the media object 360 for processing. FIG. 5 illustrates a view 600 displayed on the display 45 to the author/editor of the magazine excerpt in media object 360 after the software tool 20 has identified potentially ambiguous geographic relevant words and phrases within the media object 360 according to an exemplary embodiment.

The task of identifying the geographic relevant words (special keywords) can be accomplished by the software tool 20 scanning the magazine excerpt of the media object 360 (similar to a spell/grammar check within an application). As mentioned above, the software tool 20 may contain an ontology engine which can utilize deep analytics. The ontology engine can be used to scan the document based on a specific context such as geographic and/or location. The resultant document shown as view 600 will contain the related words/terms/phrases (i.e., geographic relevant words) highlighted. The geographic relevant words may be displayed in the view 600 (on display 45) with a different color, enclosed in a box, enclosed in a circle, and/or with any type of distinguishing feature so that the author can recognize these geographic relevant words and phrases. Also, the search for geographic relevant words is not restricted just to (textual) documents, but can be applied to audio/video multimedia formats such as, mp3 (MPEG audio layer I, II, and III) format, wmv (Windows® media video) format, avi (audio video interleave) format, etc.

In exemplary embodiments, the scanner 55 (which could be a stand-alone machine) and/or the computer system 10 may invoke a software service. For example, the media object 360 may be sent to the software service of one or more servers 305 (e.g., including one or more deep analytics machines, analytical software, and/or data mining software as understood by one skilled in the art) for processing via the network 320. The software service of the software tool 20b would execute the processing discussed above and below for the software tool 20. The software service of the software tool 20b would flag ambiguous geographical references (i.e., flag time relevant words and phrases), offer alternative wording to the user, and then provide the absolute value within the corresponding meta tags. The software service of the software tool 20b provides the user with the option (e.g., in a graphical user interface) to accept or reject these changes. As discussed herein, it is contemplated that any processes executed by the software tool 20 of the computer system 10 and the software tool 20a of the scanner 55 can be implemented by the software service of the software tool 20b.

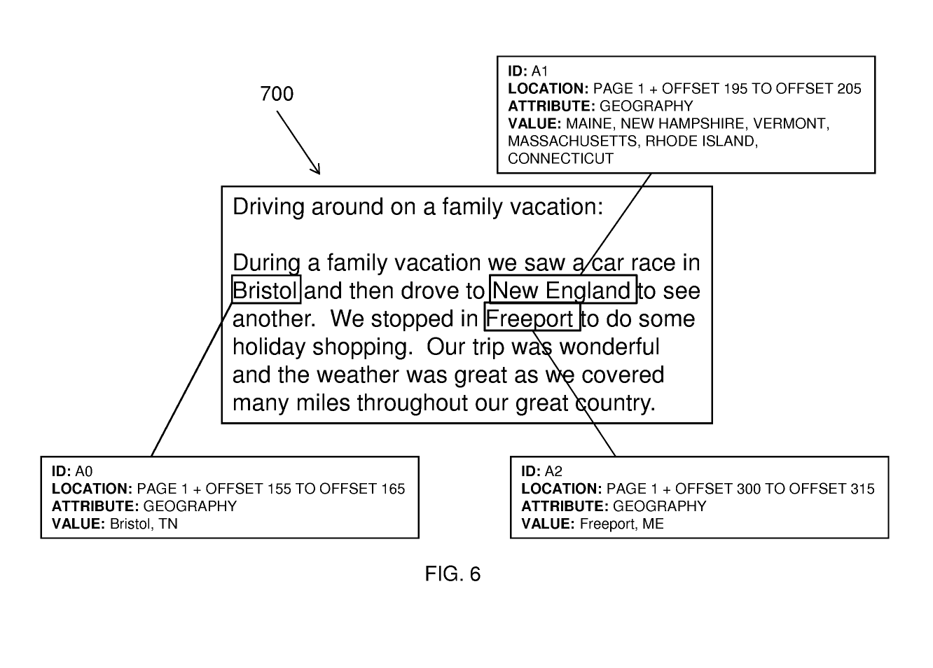

FIG. 6 illustrates a view 700 of the processed media object 360 displayed on display 45 to the author in which the software tool 20 has attached/assigned fields (as metadata) to each geographic relevant word and phrase according to an exemplary embodiment. The assigned fields may each include an identification (ID) field, a location field, an attribute field, and a value field in a metadata box that corresponds to a geographic relevant word, as shown in view 700.

After the (related keywords) geographic relevant words have been identified by the software tool 20, the location and/or geographic value for the geographic relevant words can be computed by the software tool 20 based on a reference location. A reference location can be provided directly by the editor/author and the reference location can be automatically calculated by the software tool 20 based off of the current location (e.g., as the author/editor writes the document in a word processing software application).

The software tool 20 is configured to input the data for the identification field, which is unique for each metadata box. The ID field is a unique identifier for the geographic relevant word/term/phrase/section. A special attribute with the calculated value can then be assigned by the software tool 20 to the highlighted geographic relevant words/terms/phrases as shown in view 700. The editor will have the option presented by the software tool 20 to modify the values and/or attribute for each geographic relevant word and phrase. The location field specifies the location where the attribute is within the document of the media object 360; this can be automatically computed/input by the software tool 20 and provided to the editor. The software tool 20 may provide start and end location in the location field. The attribute field is the attribute assigned to the geographic relevant word/term/phrase/section. The value field is the value of the attribute; the value field contains the actual value of the geographic relevant word.

When the software tool 20 determines and/or receives input of the reference location, the software tool 20 is configured to input the term reference location into the attribute field and the input (the actual reference location), into this value field for the metadata box; this ID field is designated as AO by the software tool 20 for this metadata box.

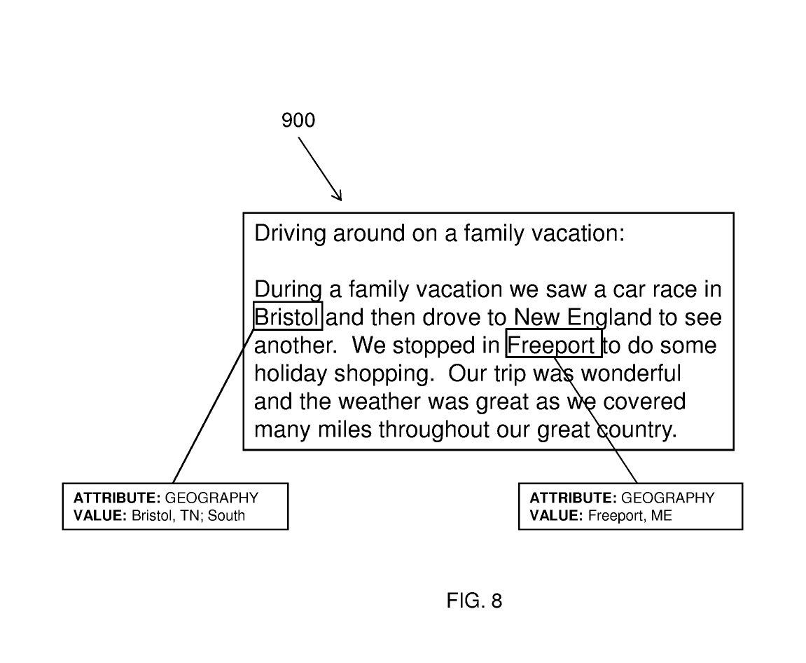

Based on receiving a reference location, the software tool 20 is configured to evaluate the value fields for each of the other identifications shown in the metadata boxes in FIG. 6. In some cases for the value field, the software tool 20 may input a region such as “New England” to go along with the (geographic relevant words) State and/or City as shown for IDs A0, A1, and A2. For all the metadata boxes in FIG. 6, the software tool 20 is configured to create metadata table 800 of the assigned/attached fields respectively corresponding to the identified geographic relevant words and phrases and embed the metadata table 800 into the media object 360, which is illustrated in FIG. 8. As the author and/or software tool 20 assigns special attributes and values to each of the geographic relevant words/terms/phrases, the software tool 20 saves this data in the media object 360 itself and/or in the memory 15. If the metadata table 800 is initially saved separately from the media object 360, the software tool 20 is configured to embed the data of the metadata table 800 directly into the (document) media object 360 where it can be utilized later by the software tool 20. In one embodiment, the software tool 20 may be integrated in a word processing application and/or presentation application, and this application can then display on the display 45 the data of the metadata table 800. Reference for assigning and embedding data can be made to application Ser. No. 12/555,171 filed Sep. 8, 2009.

When the saved (document) media object 360 is opened, the application (word processing application, document reader application, etc.) integrated with the software tool 20 can be used to read and apply the embedded data of the metadata table 800 to respective geographic relevant words and phrases. For example, when viewing the (document) media object 360 on the display 45, the reader will see the highlighted words (displayed by the software tool 20) as shown in the view 900 of FIG. 8. The saved information of the metadata table 800 can be displayed possibly through a mouse over command with the user interface 50 (and/or by a right mouse click), in which case, the embedded special attribute and value box will be displayed as shown in the view 900. Each box shows the attribute and value for one of the identified geographic relevant words and/or phrases.

For HTML (hyper text markup language) media objects 360 (documents), the software tool 20 can automatically update the meta tag keywords with the data from the value field of the metadata table 800, thereby allowing search engines (such as the search engine 335) to utilize this data of the value field. The meta tags are enclosed in the HTML head section by the software tool 20. An example is provided below:

<HEAD>

<TITLE>DOCUMENT A</TITLE>

<META name=“description” content=“This is my document.”>

<META name=“keywords” contents=“LocationX, LocationY, LocationZ”>

</HEAD>

As seen in the above example, the software tool 20 is configured to enter an actual location (value of the value field) in the keywords for the media object 360 as meta tags, which can be searched for and located by the search engine 335.

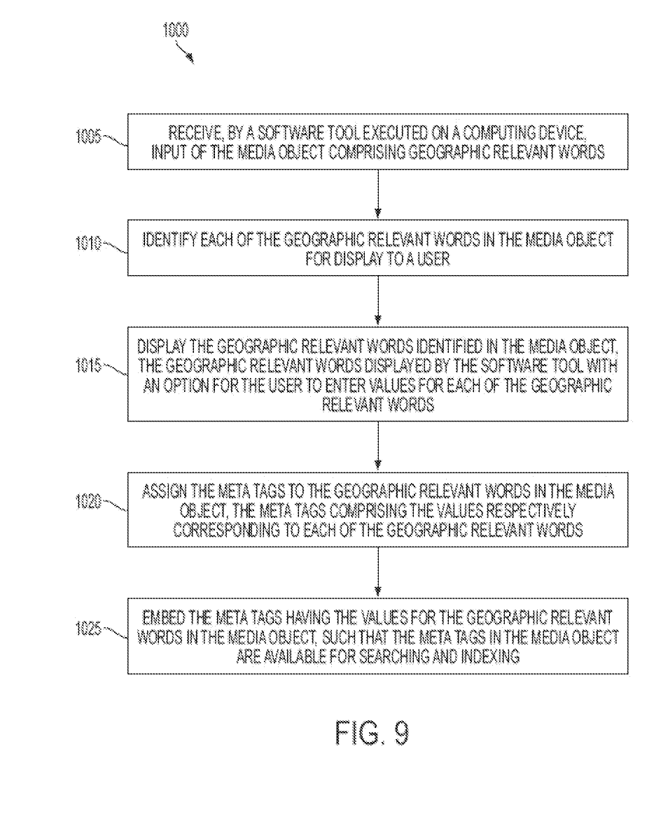

FIG. 9 illustrates a method 1000 for identifying geographic context in a media object (e.g., media object 360) to attach/embed meta tags for the geographic context in the media object according to an exemplary embodiment. Note that the processes and features discussed herein can additionally and/or alternatively be provided as a software service to the user via the server 305. The software tool 20 executing on the computing device 10 is configured to receive input of the media object 360 having potentially ambiguous geographic relevant words and phrases at block 1005. The media object 360 may be scanned in by the scanner 55, selected by the user, received in an email over the network 320, and/or downloaded over the Internet, e.g., the network 320.

At block 1010, the software tool 20 is configured to identify each of the geographic relevant words in the media object 360 for display to a user (e.g., author, editor, etc.) as shown in FIG. 5. The highlighted boxes are displayed (by the software tool 20) on the display 45 to identify each of the geographic relevant words in the media object 360. The original document of the media object 360 is shown in FIG. 1 before the software tool 20 has scanned and identified the geographic relevant words.

In exemplary embodiments, the software tool 20 is configured to display the geographic relevant words identified in the media object 360, where the geographic relevant words are displayed on the display 45 by the software tool 20 with an option for the user to enter values for each of the geographic relevant words at block 1015. As seen in FIG. 7, for each geographic relevant/sensitive word and phrase, the software tool 20 may display a metadata box with a value field (along with other fields) corresponding to a geographic/location attribute so that the user can enter the value for this geographic relevant word. The values (e.g., in the value field of the metadata table 800) are respectively included in meta tags, e.g., the value can be extracted from the metadata table 800 by the software tool 20.

At block 1020, the software tool 20 is configured to assign the meta tags to the geographic relevant words in the media object 360, such that the meta tags include the values respectively corresponding to each of the identified geographic relevant words. The software tool 20 is configured to embed the meta tags having the values for the geographic relevant words in the media object 360, such that the meta tags in the media object 360 are available for searching and indexing by the web crawlers 340 at block 1025. Also, instead of storing the meta tags in the media object 360, the software tool 20 can attach the meta tags to the media object 360 such that the meta tags are stored externally in memory 15.

The geographic relevant words may include individual words and phrases, which can include numbers, such as GPS coordinates. It is contemplated that other delineations of location may be utilized and the values corresponding to geographic relevant words are not meant to be limited. Additionally, the software tool 20 may be configured to account for different geographic regions for the values of the meta tags, and may provide absolute geographic references for geographic regions.

In exemplary embodiments, the software tool 20 is configured to automatically enter values for each of the geographic relevant words, such that the values are utilized in the meta tags. For example, in response to the user entering a reference location for the media object 360, the software tool 20 is configured to respectively calculate values for each of the geographic relevant words in the media object 360 based on this given reference location. Note that geographic relevant words, geographic relevant expressions, geographic relevant references, geographic relevant phrases, etc., are not meant to be limiting and may include words, terms, numbers, symbols, punctuations, audio, any form of character, and any combination thereof.

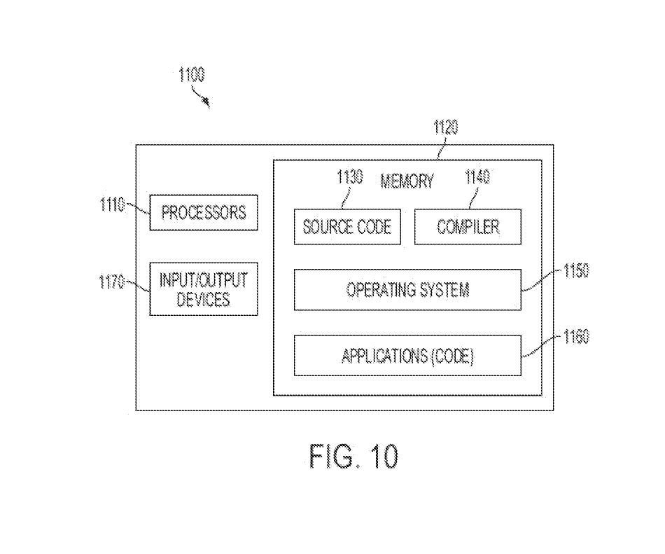

FIG. 10 illustrates an example of a computer 1100 having capabilities, which can be included in exemplary embodiments. Various methods, procedures, modules, flow diagrams, tools, application, and techniques discussed herein may also incorporate and/or utilize the capabilities of the computer 1100. Moreover, capabilities of the computer 1100 may be utilized to implement features of exemplary embodiments discussed herein. One or more of the capabilities of the computer 1100 may implement any element discussed herein such as but not limited to the computing devices/servers 10, 305, 330, and 355. Also, functionality of the computer 1100 may be utilized in the scanner 55.

Generally, in terms of hardware architecture, the computer 1100 may include one or more processors 1110, computer readable storage memory 1120, and one or more input and/or output (I/O) devices 1170 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 1110 is a hardware device for executing software that can be stored in the memory 1120. The processor 1110 can be virtually any custom made or commercially available processor, a central processing unit (CPU), a data signal processor (DSP), or an auxiliary processor among several processors associated with the computer 1100, and the processor 1110 may be a semiconductor based microprocessor (in the form of a microchip) or a macroprocessor.

The computer readable memory 1120 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 1120 may incorporate electronic, magnetic, optical, and/or other types of storage media. Note that the memory 1120 can have a distributed architecture, where various components are situated remote from one another, but can be accessed by the processor 1110.

The software in the computer readable memory 1120 may include one or more separate programs, each of which comprises an ordered listing of executable instructions for implementing logical functions. The software in the memory 1120 includes a suitable operating system (O/S) 1150, compiler 1140, source code 1130, and one or more applications 1160 of the exemplary embodiments. As illustrated, the application 1160 comprises numerous functional components for implementing the features, processes, methods, functions, and operations of the exemplary embodiments. The application 1160 of the computer 1100 may represent numerous applications, agents, software components, modules, interfaces, controllers, etc., as discussed herein but the application 1160 is not meant to be a limitation.

The operating system 1150 may control the execution of other computer programs, and provides scheduling, input-output control, file and data management, memory management, and communication control and related services.

The application(s) 1160 may employ a service-oriented architecture, which may be a collection of services that communicate with each. Also, the service-oriented architecture allows two or more services to coordinate and/or perform activities (e.g., on behalf of one another). Each interaction between services can be self-contained and loosely coupled, so that each interaction is independent of any other interaction.

Further, the application 1160 may be a source program, executable program (object code), script, or any other entity comprising a set of instructions to be performed. When a source program, then the program is usually translated via a compiler (such as the compiler 1140), assembler, interpreter, or the like, which may or may not be included within the memory 1120, so as to operate properly in connection with the O/S 1150. Furthermore, the application 1160 can be written as (a) an object oriented programming language, which has classes of data and methods, or (b) a procedure programming language, which has routines, subroutines, and/or functions.

The I/O devices 1170 may include input devices (or peripherals) such as, for example but not limited to, a mouse, keyboard, scanner, microphone, camera, etc. Furthermore, the I/O devices 1170 may also include output devices (or peripherals), for example but not limited to, a printer, display, etc. Finally, the I/O devices 1170 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 1170 also include components for communicating over various networks, such as the Internet or an intranet. The I/O devices 1170 may be connected to and/or communicate with the processor 1110 utilizing Bluetooth connections and cables (via, e.g., Universal Serial Bus (USB) ports, serial ports, parallel ports, FireWire, HDMI (High-Definition Multimedia Interface), etc.).

When the computer 1100 is in operation, the processor 1110 is configured to execute software stored within the memory 1120, to communicate data to and from the memory 1120, and to generally control operations of the computer 1100 pursuant to the software. The application 1160 and the O/S 1150 are read, in whole or in part, by the processor 1110, perhaps buffered within the processor 1110, and then executed.

When the application 1160 is implemented in software it should be noted that the application 1160 can be stored on virtually any computer readable storage medium for use by or in connection with any computer related system or method. In the context of this document, a computer readable storage medium may be an electronic, magnetic, optical, or other physical device or means that can contain or store a computer program for use by or in connection with a computer related system or method.

The application 1160 can be embodied in any computer-readable medium 1120 for use by or in connection with an instruction execution system, apparatus, server, or device, such as a computer-based system, processor-containing system, or other system that can fetch the instructions from the instruction execution system, apparatus, or device and execute the instructions. In the context of this document, a “computer-readable storage medium” can be any means that can store, read, write, communicate, or transport the program for use by or in connection with the instruction execution system, apparatus, or device. The computer readable medium can be, for example but not limited to, an electronic, magnetic, optical, or semiconductor system, apparatus, or device.

More specific examples (a nonexhaustive list) of the computer-readable medium 1120 would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W, DVD, Blue-ray™, tape, etc.) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 1160 is implemented in hardware, the application 1160 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is understood that the computer 1100 includes non-limiting examples of software and hardware components that may be included in various devices, servers, and systems discussed herein, and it is understood that additional software and hardware components may be included in the various devices and systems discussed in exemplary embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” or PLX programming language or other similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the exemplary embodiments of the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for identifying geographic context in a media object to provide meta tags for the geographic context in the media object, the method comprising:
receiving, by a software tool executed on a computing device, input of the media object comprising a plurality of geographic relevant expressions;
identifying each of the plurality of geographic relevant expressions in the media object for display to a user;
displaying each of the plurality the geographic relevant expressions identified in the media object, the geographic relevant expressions displayed by the software tool with an option for the user to enter values for each of the geographic relevant expressions;
wherein the values are respectively comprised in the meta tags; and
assigning the meta tags to the geographic relevant expressions in the media object, the meta tags comprising the values respectively corresponding to each of the geographic relevant expressions.

2. The method of claim 1, further comprising at least one of:
embedding the meta tags having the values for the geographic relevant expressions in the media object, such that the meta tags in the media object are available for searching and indexing; and
attaching the meta tags containing the values for the geographic relevant expressions to the media object;
wherein the geographic relevant expressions comprise individual words and phrases.

3. The method of claim 1, wherein the values of the meta tags comprise a location in which the location comprises at least one of a region, a state, and a city or a combination thereof.

4. The method of claim 1, wherein the software tool is configured to enter the values for each of the geographic relevant expressions, such that the values are utilized in the meta tags.

5. The method of claim 1, wherein the media object comprises at least one of a multimedia file, an audio file, and a soft copy of a document.

6. A computing device configured for identifying a geographic context in a media object to provide a meta tag for the geographic context in the media object, comprising:
a processor;
a software tool configured to operate on the processor, the software tool being configured to:
receive input of the media object comprising a geographic relevant expression;
identify the geographic relevant expression in the media object for display to a user;
display the geographic relevant expression identified in the media object, the geographic relevant expression displayed with an option for the user to enter a value for the geographic relevant expression;
wherein the value is comprised in the meta tag; and
assign the meta tag to the geographic relevant expression in the media object, the meta tag comprising the value corresponding to the geographic relevant expression.

7. The device of claim 6, wherein the software tool is configured to at least one of
embed the meta tag having the value for the geographic relevant expression in the media object, such that the meta tag in the media object is available for searching and indexing; and
attach the meta tag having the value for the geographic relevant expression to the media object; and
wherein the geographic relevant expression comprise individual words and phrases.

8. The device of claim 6, wherein the value of the meta tag comprises a location comprising at least one of a region, a state, and a city.

9. The device of claim 6, wherein the software tool is configured to enter the value for the geographic relevant expression, such that the value is utilized in the meta tag.

10. The device of claim 6, wherein, in response to the user entering a reference location for the media object, the software tool is configured to respectively calculate the value for each of the geographic relevant expression in the media object based on the reference location.

11. The device of claim 6, wherein the media object comprises at least one of a multimedia file, an audio file, and a soft copy of a document.

12. A computer program product for identifying geographic context in a media object to provide meta tags for the geographic context in the media object via a computing device, the computer program product comprising:
a computer readable storage medium having computer readable program code embodied therewith, the computer readable program code being configured for:
receiving, by a software tool executed on a computing device, input of the media object comprising a plurality of geographic relevant expressions;
identifying each of the plurality of geographic relevant expressions in the media object for display to a user;
displaying each of the plurality the geographic relevant expressions identified in the media object, the geographic relevant expressions displayed by the software tool with an option for the user to enter values for each of the geographic relevant expressions;
wherein the values are respectively comprised in the meta tags; and
assigning the meta tags to the geographic relevant expressions in the media object, the meta tags comprising the values respectively corresponding to each of the geographic relevant expressions.

13. The computer program product of claim 12, further comprising at least one of:
embedding the meta tags having the values for the geographic relevant expressions in the media object, such that the meta tags in the media object are available for searching and indexing; and
attaching the meta tags containing the values for the geographic relevant expressions to the media object;
wherein the geographic relevant expressions comprise individual words and phrases.

14. The computer program product of claim 12, wherein the values of the meta tags comprise a location in which the location comprises at least one of a region, a state, and a city or a combination thereof.

15. The computer program product of claim 12, wherein the software tool is configured to enter the values for each of the geographic relevant expressions, such that the values are utilized in the meta tags.

16. The computer program product of claim 12, wherein the media object comprises at least one of a multimedia file, an audio file, and a soft copy of a document.

17. A method for identifying geographic context in a media object, the method comprising:
receiving, by a software tool executed on a computing device, input of the media object comprising one or more geographic relevant expressions;
identifying each of the one or more geographic relevant expressions in the media object for display to a user in response to at least one of the user editing in a document of the media object and a scan being performed for geographic accuracy of the document; and
displaying the one or more geographic relevant expressions identified in the media object, the one or more geographic relevant expressions being displayed by the software tool with at least one of a suggestion of an alternative wording for the geographic relevant expressions and an option for the user to correct the one or more geographic relevant expressions.

18. The method of claim 17, further comprising receiving a metric for determining a degree of the geographical accuracy for the document.

19. A computer program product embodied on a computer readable medium comprising computer executable instructions to execute the method of claim 1.
